(19) United States
(12) Patent Application Publication
(10) Pub. No.: US 2008/0069045 A1
(43) Pub. Date: Mar. 20, 2008

(54) Device for Allocating Shared Resources of a Communication Network, by Assignment of Time Slots of a Dynamically Adaptable Time/Frequency Plan

(75) Inventors: Luc Delamotte, Toulouse (FR); David Niddam, Tournefeuille (FR); Christophe Gerrier, Bois Colombes (FR); Xavier Denis, Colombes (FR); Cecile Faure, Toulouse (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/573,184

(22) PCT Filed: Jun. 23, 2005
(86) PCT No.: PCT/FR05/50486

§ 371 Date: Oct. 18, 2007

(30) Foreign Application Priority Data
Aug. 5, 2004 (FR) 0408655

(51) Int. Cl. H04Q 7/00

(52) U.S. Cl. 370/330

(57) ABSTRACT

A device (D) is dedicated to the allocation of shared resources on a return link between terminals (UE) and a communication management equipment (GW) of a communication network. It comprises processing means (MT) adapted, firstly, to determine a set of time/frequency plans as a function of at least one symbol rate capacity requested for a set of user terminals (UE) and a designation of a chosen set of frames, each defined by a chosen set of time slots of the same type, with a view to its transmission to each of the user terminals (UE) of the set, and, secondly, each time that a user terminal (UE) requests at least one capacity, to determine at least one suitable symbol rate taking account of the requested capacity and a corresponding time slot, called the optimum slot at the time of determination, from the time/frequency plans that have been determined, so as to optimize the allocation of the shared resources of the network.

The invention concerns the field of communication networks with allocation of shared resources, and more precisely the allocation of shared resources on the return link between user terminals and communication management stations of such networks.

Networks with allocation of shared resources, also called two-way broadband or two-way narrowband networks, such as multifrequency-time division multiple access (MF-TDMA) networks, for example, use what the man skilled in the art calls time/frequency plans for the allocation of shared resources on the return links.

A time/frequency plan is an arrangement of one or more types of carrier “transporting” time slots intended to be allocated to the various user terminals for the transport of data or of signals. Here “carrier type” means carriers having different frequencies and/or different symbol rates and/or different coding rates and/or using different modulations.

The time/frequency plans are generally established in advance on the basis of a model of predicted traffic matrices and of expected user distribution, in order to obtain during operation an optimum configuration of the return link. A plurality of configurations may be (pre)defined in order to respond to variations in users' requirements.

The change from one configuration to the other necessitates a certain time and generally corresponds to predefined time slots of known user profiles. Because of this, any difference relative to the initial model or the initial profiles may lead to degraded use of resources, since no configuration will then have been provided. This deterioration is particularly harmful in the case of satellite networks for reasons of cost. Moreover, any change of configuration, and thus of time/frequency plan, must be signaled to each user terminal by means of dedicated signaling messages transmitted over the air interface, which induces additional delays and necessitates the use of additional resources.

In the presence of a slow, and substantially continuous evolution, it is possible to define new sets of configurations better adapted to the situation. On the other hand, in the presence of more dynamic load variations (such as an event consuming a great deal of capacity, for example) and/or an unpredictable and/or sudden event (such as rain, for example) impacting on the capacity available on the return link, the predefined time/frequency plans may prove unsuitable or even amplify the disturbing phenomenon. In this case, bottlenecks appear, thus reducing the usable capacity of the network and its efficacy. A correlated deterioration in the quality of service of each user terminal occurs, in particular in the case of low-cost terminals that are often more sensitive to signal attenuation since their transmit power is limited.

Moreover, the distribution between carriers of different types imposes a breakdown into as many aggregates as there are types, which limits the possibilities of statistical multiplexing by aggregates.

Furthermore, the number of time/frequency plans to be predefined may be very high, without necessarily covering all situations, and difficult to configure and to manage.

To facilitate the configuration of the return link with different carrier types, in MF-TDMA type networks a standard known as DVB-RCS has been proposed. Such a standard is described in particular in the document “Digital Video Broadcast (DVB); Interaction channel for satellite distribution systems”, ETSI EN 301 790 V1.3.1 (2003-03).

According to this standard, the return link is divided into superframes, themselves divided into frames which are themselves divided into time slots. A superframe is a selected portion of times and of frequencies made up of frames, the simultaneous number of which cannot exceed 32 and each consisting of time slots the simultaneous number of which cannot exceed 2048. To define a given time/frequency plan, the frames and the time slots are classified (numbered) from the lowest frequency and from the first time to the highest frequency and the last time, relative to the center frequency and the time origin of the superframe. As a result, each frame of a superframe defines a usable time/frequency plan portion. Each user terminal is advised of the time slot that it must use within a frame of a superframe by means of dedicated messages transmitted by the communication management station of its network, known as burst time plans.

Because of the classification (or numbering) of the frames, the time/frequency plans may be regarded as similar to two-dimensional (2D) puzzles in which each piece is defined in the standard by a frame. Consequently, at a given time and for a given time/frequency plan, only one combination of frames (only one puzzle) is potentially accessible to a user terminal. This combination of accessible frames and the respective arrangements of those frames within the superframe are therefore predefined and can be modified only by means of dedicated commands, which does not correspond to real time and/or adaptive processing.

This scheme of puzzles (or plans) induces a partitioning of the global capacity of the return link that significantly limits the effect of statistical multiplexing. Moreover, each piece of the puzzle must be preconfigured in order for the complete puzzle to be compatible with the predicted traffic matrix model. The DVB-RCS standard undoubtedly enables the predefined puzzle to be modified by changing its pieces (or frames) and/or their arrangement in the superframe to obtain a new time/frequency plan, but each modification (or updating) of the contents of the superframes and of the frames must be signaled to each user terminal by means of a dedicated signaling message, which takes time and consumes bandwidth. Furthermore, the problem of the configuration of the new puzzle best adapted to a new situation remains intact.

No known solution being entirely satisfactory, an object of the invention is therefore to improve on the situation.

To this end it proposes a shared resource allocation device comprising processing means adapted:
to determine a set of time/frequency plans as a function of at least one symbol rate capacity requested for a set of user terminals and a designation of a chosen set of frames, each defined by a chosen set of time slots of the same type, with a view to its transmission to each of those user terminals, and
each time that a user terminal requests at least one capacity, to determine at least one suitable symbol rate taking account of said requested capacity and a corresponding time slot, called the optimum slot at the time of determination, from the time/frequency plans that have been determined, so as to optimize (and preferably maximize) the allocation of the shared resources of the network.

The device according to the invention may have other features and in particular, separately or in combination:
its processing means may be adapted to determine each optimum time slot either substantially in real time, immediately on reception of a request from a user terminal, or periodically and following the reception of a request from a user terminal,
each time/frequency plan from the set of plans that has been determined may consist of a chosen single frame, the frames of the set substantially covering the same frequency band and the same time portion, ignoring a possible offset; in this case the processing means are adapted, on reception of requests from user terminals, to determine and then to allocate optimum time slots from the set of plans that has been determined for each of the requesting user terminals, and then to transmit those optimum time slots, which together constitute an optimum time/frequency plan, to demodulator means of the communication management equipment in order that they may be configured,
its processing means may be adapted to determine the optimum time slot additionally as a function of a state of the transmission channel of the requesting user terminal substantially at the time of the processing of the request and/or of a load state of the network substantially at the time of the request processing,
if the network is of MF-TDMA type, the processing means may be adapted to offset the plans of the set that has been determined relative to each other in time and/or in frequency, so that they can be easily distinguished; in this case, the offset preferably conforms to the DVB-RCS return link configuration standard,
its processing means may also be adapted to determine the optimum time slots from the set of time/frequency plans to be allocated to the user terminals that has been determined using a capacity distribution algorithm, for example the weighted fair queuing algorithm,
its processing means may also be adapted to build the optimum time/frequency plan by means of an available resource filling algorithm, for example the carrier load algorithm, using the optimum time slots determined by means of the capacity distribution algorithm,
alternatively, the processing means may be adapted to assign an identifier to each of the time/frequency plans of the set that has been determined.

The invention also proposes a resource allocation controller for a return link subsystem of the communication management equipment of a communication network, equipped with a resource allocation device of the type described hereinabove.

The invention further proposes a return link subsystem for a communication management equipment of a communication network, equipped with a resource allocation controller of the type described hereinabove or a resource allocation device of the type described hereinabove.

The invention further proposes communication management equipment for a communication network with allocation of shared resources, equipped with a return link subsystem of the type described hereinabove or a resource allocation device of the type described hereinabove.

The invention is particularly well adapted, although not exclusively so, to MF-TDMA type networks, and more particularly to those of satellite type (the communication management equipment then being a satellite station (or gateway)).

Other features and advantages of the invention will become apparent on examining the following detailed description and the appended drawings, in which:

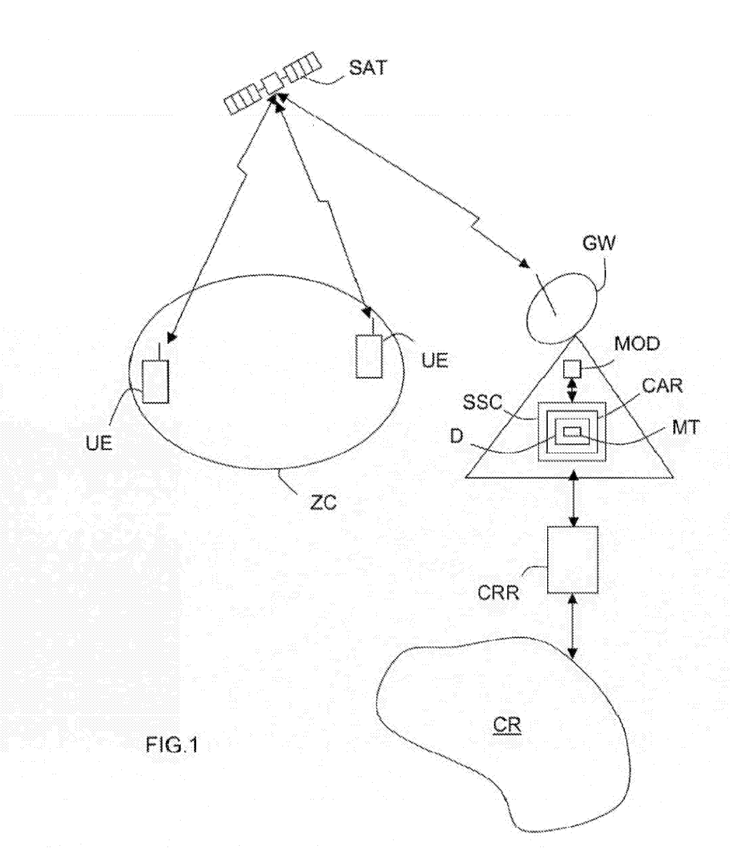

FIG. 1 shows diagrammatically a portion of one example of a satellite communication network including a shared resource allocation device according to the invention,

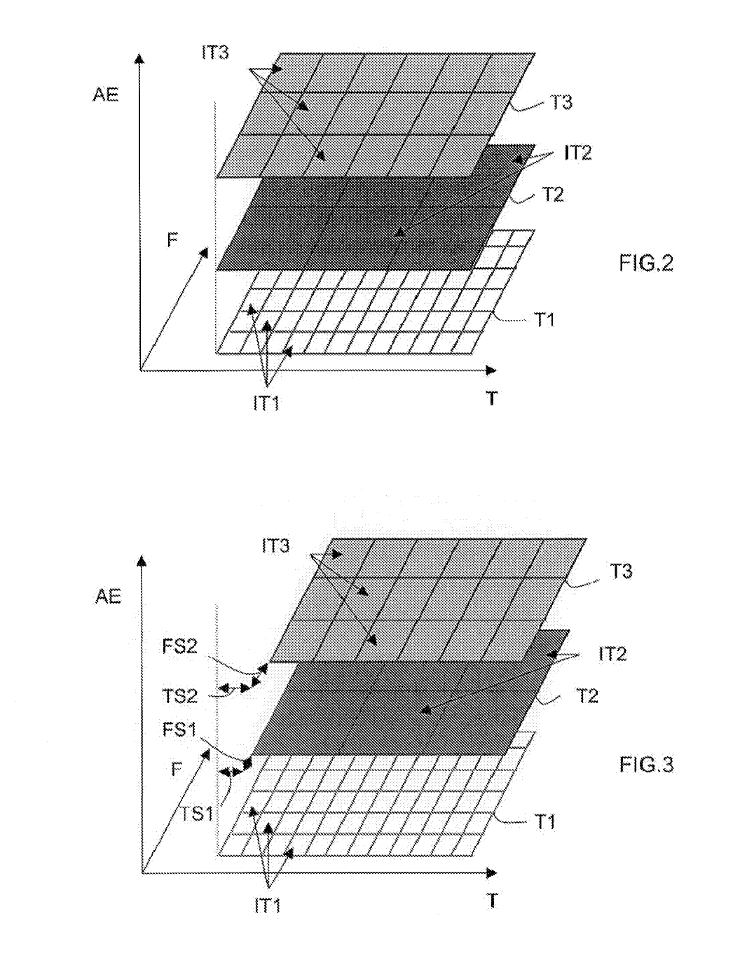

FIG. 2 shows diagrammatically a first example of a superframe according to the invention,

FIG. 3 shows diagrammatically a second example of a superframe according to the invention, and

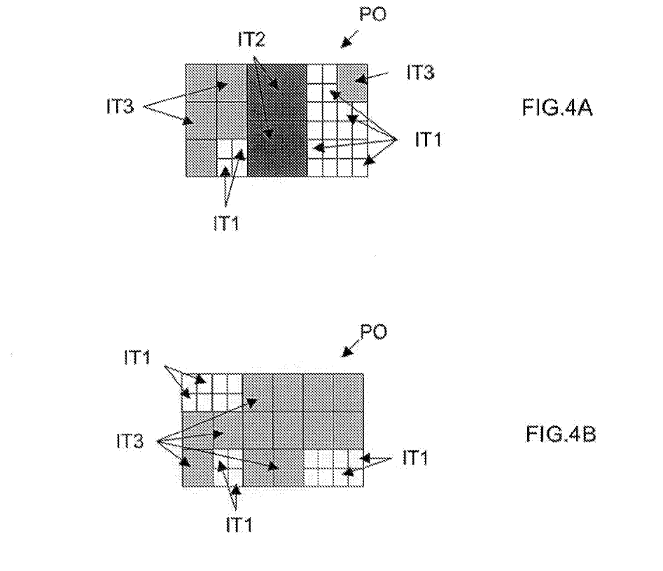

FIGS. 4A and 4B show diagrammatically two examples of two optimum time/frequency plans PO according to the invention.

The appended drawings constitute part of the description of the invention as well as contributing to the definition of the invention, if necessary.

An object of the invention is to enable optimized and adaptive management of shared resources of the return link of a communication network with allocation of shared resources.

It is considered hereinafter, by way of nonlimiting example, that the network with allocation of shared resources is a multifrequency time division multiple access (MF-TDMA) satellite network. The invention is not limited to satellite type networks or to MF-TDMA type networks, however. In fact it concerns all terrestrial or satellite networks including two-way broadband or two-way narrowband channels and using time/frequency plans for the allocation of shared resources to their return links (i.e. between the user terminals and the communication management equipments).

Moreover, it is considered hereinafter, by way of illustrative example, that the communication network is a broadband type network, but it could equally well be a narrowband network, such as a 3G network, for example, such as an IS-95 network.

As shown in FIG. 1, very broadly speaking but nevertheless in sufficient detail for an understanding of the invention, the satellite communication network may be summarized as comprising a core network CR coupled to a satellite access network.

The satellite access network includes firstly at least one communication management equipment, represented here in the form of a satellite station or gateway GW connected to the core network CR by a radio network controller CRR, and at least one telecommunication satellite SAT enabling exchange of data by radio between the gateway SG and user terminals UE equipped with a satellite transceiver.

Here “user terminal” means any network equipment capable of exchanging data in the form of signals either with another equipment, via their parent network(s), or with its own parent network. For example, it may be a fixed or portable computer, a fixed or mobile telephone, a personal digital assistant (PDA) or a server.

It is considered hereinafter, by way of illustrative example, that the user terminals UE are satellite mobile telephones.

The satellite link constitutes an air type satellite interface. Moreover, the radio network controller CRR provides the service and control functions at the same time, for example.

The gateway SG is in particular responsible for processing of the signal and for management of requests for access to the satellite network. The satellite SAT is additionally associated with one or more radio cells situated in each of its coverage areas ZC. In the example shown, the satellite SAT covers only one cell, which corresponds to a single beam.

The gateway SG includes in particular a return link subsystem SSC including a resource allocation controller CAR responsible in particular for controlling the modem MOD. The return link subsystem SSC also provides return link monitoring and control functions (from user terminals UE to the satellite stations GW) and generates some or all of the signaling necessary for the operation of this return link. The resource allocation controller CAR also provides return link shared resource access control functions.

For efficient and adaptive management of the resources of the network on the return link, the invention proposes a shared resource allocation device D.

As shown in FIG. 1, the device D is preferably installed in the resource allocation controller CAR. This is not obligatory, however. It could in fact be part of the return link subsystem SSC and be coupled to the resource allocation controller CAR or external to the return link subsystem SSC and coupled thereto, more precisely to its resource allocation controller CAR.

The device D includes primarily a processing module MT responsible firstly for determining, on command or periodically, a set of time/frequency plans as a function, on the one hand, of at least one symbol rate capacity that has been requested for a set of user terminals, for example by their network access provider, and, on the other hand, on the designation of a chosen set of frames Ti (i is an integer greater than 2 and generally less than or equal to 32), each defined by a chosen set of time slots ITi of the same type.

Here “time slots of the same type” means time slots of a frame Ti associated with a given carrier type and therefore all associated with the same symbol rate.

According to the invention, each time/frequency plan of a set of plans determined by the processing module MT consists of a single chosen frame Ti. In other words, the frames Ti of the same set cover substantially the same band of frequencies and the same time portion, ignoring any offset, as explained hereinafter with reference to FIG. 3.

Each set of time/frequency plans can therefore be seen as a stack of frames Ti along an axis AE, or as a three-dimensional (3D) time/frequency plan, as opposed to a standard two-dimensional (2D) time/frequency plan.

A nonlimiting overall example including three time/frequency plans and thus three frames T1 to T3 (i=1 to 3) is shown in FIG. 2. In this example, firstly, the frame T1 includes 72 (12×6) time slots IT1 of a first type, obtained by dividing the time portion into 12 parts of equal duration and dividing the frequency band into six equal parts, secondly, the frame T2 includes 6 (3×2) time slots IT2 of a second type, obtained by dividing the time portion into three parts of equal duration and dividing the frequency band into two equal parts, and, thirdly, the frame T3 includes 18 (6×3) time slots IT3 of a third type, obtained by dividing the time portion into six parts of equal duration and dividing the frequency band into three equal parts. Remember that in this type of representation the greater the area of a time slot the more it corresponds to a high symbol rate.

As shown in FIG. 3, the frames Ti of a set (each of which constitutes a time/frequency plan) may be offset relative to each other in time (T) and/or in frequency (F). More precisely, in the example shown, the second frame T2 is offset relative to the first frame T1 (which constitutes the absolute time and frequency reference) by a first time value TS1 and a first frequency value FS1, and the third frame T3 is offset relative to the first frame T1 by a second time value TS2 (here greater than TS1) and a second frequency value FS2 (here greater than FS1). Of course, other examples of shifts may be envisaged, and in particular an example in which some frames of a set are shifted in time and some others are shifted in frequency.

This variant with shifts is particularly well adapted to the DVB-RCS return link configuration standard described hereinabove. In fact, it enables the frames Ti to be distinguished from each other by means of their respective time and frequency origins without having to assign each of them an identifier or number.

The amplitude of each offset is then chosen to conform to the DVB-RCS standard, which authorizes a maximum frequency offset of 100 Hz and a maximum time offset of 1/27 MHz (i.e. 17 ns).

This enables use of the signaling defined by the DVB-RCS standard to transmit to each of the user terminals concerned the definition of the set of frames (or time/frequency plans) that concern them. This is advantageous because it avoids defining new signaling messages that would necessitate an adaptation of the user terminals UE.

However, a variant may be envisaged in which the frames Ti of each set are distinguished from each other by identifiers or numbers assigned by the processing module MT.

Whatever the mode of distinguishing between them employed, once the processing module MT has defined a set of frames (or time/frequency plans) dedicated to a set of user terminals UE, as a function at least of a symbol rate capacity, the definition of that set is transmitted by the gateway GW to said user terminals UE, here via the satellite SAT. The other parameters that can be taken into account for the definition of the set of frames include in particular the center frequency of the set (or superframe).

The processing module MT is also responsible, each time that a user terminal UE requests at least one capacity, for determining an optimum time slot from the time/frequency plans of the set corresponding to said terminal user UE, which it has previously determined.

The word “optimum” must be understood as relative to the time of determination, i.e. the time at which the request is processed by the processing module MT. In other words, a time slot may be the optimum for one user terminal at a given time, given the state of the network and where appropriate the quality of service (QoS) associated with the user terminal UE concerned, and no longer be so at another time because said network is in another state.

This optimum slot determination is effected as a function at least of the capacity requested by the requesting user terminal. It preferably takes into account the quality of service (QoS) associated with the user terminal UE concerned. However, it may equally well be effected as a function of at least one complementary parameter such as a state (at the time of the processing of the request by the processing module MT) of the transmission channel of the requesting user terminal UE, for example, such as the measured level of the signal transmitted in the channel associated with the time slot used by the user terminal UE, or a load state of the network at the time of processing of the request by the processing module MT (representative of its congestion or its non-congestion, for example). Remember that the load state of the network impacts on the capacity that can be allocated to a user terminal.

If the processing module MT receives from different user terminals UE requests to obtain respective capacities, at least, it determines among the frames Ti of the current set those that are the most appropriate for each of the time slots IT to be assigned to said requesting user terminals. In other words, the processing module MT determines for each requesting user terminal UE the symbol rate that is the best adapted to the capacity that it has requested, given the state of the network. Each symbol rate determined in this way is then the optimum, relative to the time of determination, for the user terminal concerned.

Each frame Ti of a particular set corresponding to a given symbol rate, to each optimum rate there therefore corresponds a time slot IT for a given user terminal UE. Each of the time slots IT, corresponding to an optimum symbol rate and coming from one or the other of the frames Ti of the set previously determined, is referred to as the optimum relative to the time of determination.

The processing module MT can, for example, determine the time slots that are the optimum at a given time by means of a capacity distribution algorithm such as the weighted fair queuing algorithm used in many networks. Remember that an algorithm of this type distributes capacity as a function or attributes linked, for example, to the quality of service (QoS) and/or the contract of each user.

Determining optimum time slots enables optimization, and preferably maximization, of the allocation of the shared resources of the network.

When the processing module MT has determined the optimum time slots for the requesting user terminals UE, given the above parameter or parameters, the gateway GW transmits to each of them, here via the satellite SAT, a dedicated message designating the optimum time slot that it must use in order for the corresponding shared resources to be allocated to them. If the DVB-RCS standard is used, the dedicated message is the terminal burst time plan (TBTP).

On receipt of this dedicated message, the user terminal UE is capable of determining in the last definition of the set of valid time/frequency plans, which it has previously received, the definition of the time slot that it must use.

Also, the processing module MT transmits to the modem MOD, in an interpretable format, the optimum time slots that it has determined. In fact, they together constitute an optimum time/frequency plan for configuring the demodulator portion of modem MOD.

For example, the processing module MT may determine dynamically the set of optimum time slots that constitute an optimum time/frequency plan by means of an available resource filling algorithm such as the carrier load algorithm developed by Alcatel.

This optimum time/frequency plan PO, which results from this dynamic determination of the optimum time slots, is of 2D type, and not of 3D type.

Two examples of optimum time/frequency plans are shown diagrammatically in FIGS. 4A and 4B. They correspond, for example, to two determinations effected at two different times from the set of frames Ti (or of time/frequency plans) from FIG. 2 or 3.

More precisely, in the example shown in FIG. 4A the optimum time/frequency plan PO consists, firstly, of six time slots IT3 coming from the third frame T3, secondly, of 24 time slots IT1 coming from the first frame T1, and, thirdly, of two time slots IT2 coming from the second frame T2.

In the example shown in FIG. 4B the optimum time/frequency plan PO consists, firstly, of 13 time slots IT3 coming from the third frame T3, and, secondly, time slots IT1 coming from the first frame T1. In contrast to the first example, no time slot IT2 coming from the second frame T2 is retained (or selected) here in constituting the new optimum time/frequency plan. Consequently, in this example, no requesting user terminal has been able to obtain the benefit of the highest symbol rate.

It will be noted that in certain situations the symbol rate requested by a user terminal UE (by means of its capacity request) may be less than at least one of the symbol rates of the time slots of different types that at a given time constitute an optimum time/frequency plan.

It is important to note that the optimum time slots may be determined either substantially in real time, i.e. following the reception of requests coming from the user terminals UE, or with a slight delay, i.e. a few moments after the reception of said requests. In the latter case, each determination time may be predefined, for example to comply with a chosen periodicity.

The shared resource allocation device D according to the invention, and in particular its processing module MT, may be produced in the form of electronic circuits, software (or electronic data processing) modules, or a combination of circuits and software.

Thanks to the invention, it is no longer necessary to configure a multitude of time/frequency plans in advance. There is virtually no limit on the number of possibilities offered by the invention. Moreover, it is no longer necessary to transmit signaling messages over the air interface each time that a new time/frequency plan is applied. Furthermore, the invention can reduce very significantly the number of bottlenecks induced by the predefined frames of the prior art. Also, the invention maintains statistical multiplexing and can be used in the context of the DVB-RCS standard. Finally, the invention allocates to each user terminal at all times the time slot of the type best adapted to his requirements at that time given the state of the network at the time concerned, which optimizes the use of the shared resources of the network.

The invention is not limited to the shared resource allocation device, resource allocation controller, return link subsystem and communication management equipment embodiments described hereinabove by way of example only, but encompasses all variants that the man skilled in the art might envisage that fall within the scope of the following claims.

1. Device (D) for allocation of shared resources on a return link between terminals (UE) and a communication management equipment (GW) of a communication network, characterized in that it comprises processing means (MT) adapted i) to determine a set of time/frequency plans as a function of at least one symbol rate capacity requested for a set of user terminals (UE) and a designation of a chosen set of frames, each defined by a chosen set of time slots of the same type, for to its transmission to each of the user terminals (UE) of said set, and ii) each time that a user terminal (UE) requests at least one capacity, to determine at least one suitable symbol rate taking account of said requested capacity and a corresponding time slot, called the optimum slot at the time of determination, from said time/frequency plans that have been determined, so as to optimize the allocation of the shared resources of said network.

2. Device according to claim 1, characterized in that said processing means (MT) are adapted to determine each optimum time slot substantially in real time, on reception of a request from at least one user terminal (UE).

3. Device according to claim 1, characterized in that said processing means (MT) are adapted to determine each optimum time slot periodically and following the reception of a request from at least one user terminal (UE).

4. Device according to claim 1, characterized in that each time/frequency plan from the set of plans that has been determined consists of a chosen single frame, said frames of the set substantially covering the same frequency band and the same time portion, ignoring a possible offset, and in that said processing means (MT) are adapted, on reception of requests from user terminals (UE), to determine and then to allocate optimum time slots for each of said requesting user terminals (UE), and then to transmit those optimum time slots, which together constitute an optimum time/frequency plan, to demodulator means (MOD) of said communication management equipment (GW) in order that they may be configured.

5. Device according to claim 1, characterized in that said processing means (MT) are adapted to determine each optimum time slot additionally as a function of a state of the transmission channel of the requesting user terminal (UE) substantially at the time of the processing of the request and/or of a load state of said network substantially at the time of said request processing.

6. Device according to claim 1, characterized in that, said network being of MF-TDMA type, said processing means (MT) are adapted to offset the plans of the set that has been determined relative to each other in time and/or in frequency.

7. Device according to claim 6, characterized in that said offset conforms to the DVB-RCS return link configuration standard.

8. Device according to claim 1, characterized in that said processing means (MT) are adapted to assign an identifier to each of said time/frequency plans of the set that has been determined.

9. Device according to claim 1, characterized in that said processing means (MT) are adapted to determine said optimum time slots from the set of time/frequency plans that has been determined using a capacity distribution algorithm.

10. Device according to claim 9, characterized in that said capacity distribution algorithm is the weighted fair queuing algorithm.

11. Device according to claim 9 characterized in that each time/frequency plan from the set of plans that has been determined consists of a chosen single frame, said frames of the set substantially covering the same frequency band and the same time portion, ignoring a possible offset, and in that said processing means (MT) are adapted, on reception of requests from user terminals (UE), to determine and then to allocate optimum time slots for each of said requesting user terminals (UE), and then to transmit those optimum time slots, which together constitute an optimum time/frequency plan, to demodulator means (MOD) of said communication management equipment (GW) in order that they may be configured, and further characterized in that said processing means (MT) are adapted to build said optimum time/frequency plan by means of an available resource filling algorithm using said optimum time slots determined by means of said capacity distribution algorithm.

12. Device according to claim 11, characterized in that said available resource filling algorithm is the carrier load algorithm.

13. Resource allocation controller (CAR), for a return link subsystem (SSC) of a communication management equipment (GW) of a communication network, characterized in that it comprises a resource allocation device (D) according to claim 1.

14. Return link subsystem (SSC) for a communication management equipment (GW) of a communication network, characterized in that it comprises a resource allocation controller (CAR) according to claim 13.

15. Return link subsystem (SSC) for a communication management equipment (GW) of a communication network, characterized in that it comprises a resource allocation device (D) according to claim 1.

16. Resource management equipment (GW) of a communication network, characterized in that it comprises a return link subsystem (SSC) according to claim 14.

17. Resource management equipment (GW) of a communication network, characterized in that it comprises a resource allocation device (D) according to claim 1.

18. Equipment according to claim 16, characterized in that it constitutes a satellite station of a satellite communication network.
